(19) United States
(12) Patent Application Publication
(10) Pub. No.: US 2020/0045242 A1
(43) Pub. Date: Feb. 6, 2020

(54) DISPLAY CONTROL DEVICE, DISPLAY CONTROL METHOD, AND PROGRAM

(71) Applicant: CANON KABUSHIKI KAISHA, Tokyo (JP)

(72) Inventor: Tetsuhiro Funagi, Tokyo (JP)

(21) Appl. No.: 16/518,297

(22) Filed: Jul. 22, 2019

(30) Foreign Application Priority Data
Jul. 31, 2018 (JP) 2018-143506

(51) Int. Cl. H04N 5/262; H04N 5/232; G06K 9/00; H04N 7/18

(52) U.S. Cl. CPC H04N 5/2628; H04N 5/23296; G06K 9/00771; G06K 2009/00738; G06K 9/00362; H04N 7/183; G06K 9/00718

(57) ABSTRACT

Causing display of an image captured by an image capturing device. An acquisition unit acquires a classification of an event occurring in a capturing area in which the image capturing device performs capturing. A display control unit causes a display unit to display an image generated by enlargement processing such that a size of a portion of a human figure included in the image of the capturing area is identical to a predetermined size, the portion of the human figure corresponding to the classification of the event acquired by the acquisition unit.

### BACKGROUND OF THE INVENTION

### Field of the Invention

The present disclosure relates to a technology of causing display of an image captured by an image capturing device.

### Description of the Related Art

Conventionally, in a monitoring system in which respective images captured by a plurality of image capturing devices are displayed in arrangement on a display, there is a technology of enlarging and displaying an image to be verified in more detail onto the display from the plurality of images displayed in arrangement on the display.

According to Japanese Patent Laid-Open No. 2011-97309, in a monitoring system in which centralized monitoring is performed with respective video images of a plurality of monitoring cameras, displayed in arrangement, the video image of a monitoring camera capturing a human figure having a degree of abnormality more in motion than a predetermined value, is displayed in enlargement at the center of a display screen.

There is a technology of detecting an event occurring in the capturing area in which an image capturing device performs capturing, by performance of analytical processing to an image captured by the image capturing device or by use of a sensor, such as a human detection sensor or a motion sensor. Note that examples of detection of the event include moving object detection of detecting a moving object in the capturing area and human body detection of detecting a human body in the capturing area.

In accordance with the classification of an event occurring in the capturing area in which an image capturing device performs capturing, the target that user desires to verify varies in the captured image.

However, according to Japanese Patent Laid-Open No. 2011-97309, without consideration of the classification of an event, the video image of a monitoring camera capturing a human figure having a degree of abnormality more in motion than the predetermined value, is displayed in enlargement at the center of the display screen, uniformly.

### SUMMARY OF THE INVENTION

In order to cause the portion that a user desires to verify, to be visually identified, in accordance with the classification of an event occurring in a capturing area, for example, a display control device according to an embodiment of the present disclosure has the following configuration. That is, the display control device configured to cause a display unit to display an image captured by an image capturing device, includes an acquisition unit and a display control unit. The acquisition unit is configured to acquire a classification of an event occurring in a capturing area in which the image capturing device performs capturing. The display control unit is configured to cause the display unit to display an image generated by enlargement processing with respect to a specific portion of a human figure included in the image of the capturing area, in which the specific portion varies in accordance with the classification of the event acquired by the acquisition unit.

Further features of the present disclosure will become apparent from the following description of exemplary embodiments (with reference to the attached drawings).

### BRIEF DESCRIPTION OF THE DRAWINGS

FIG. 1 is an illustration of the configuration of a system.

FIG. 2 is an illustration of the external appearance of an image capturing device.

FIG. 3 is an illustration of the functional blocks of the image capturing device.

FIG. 4 is an illustration of the functional blocks of a display control device.

FIGS. 5A and 5E are each an illustration of an exemplary display screen.

FIG. 6 is an illustration of an exemplary table in which the classification of an event is associated with the portion of a human figure.

FIGS. 7A and 7B are flowcharts of a flow of processing of enlarging an image.

FIG. 8 is an illustration of the functional blocks of a display control device.

FIGS. 9A and 9B are each an illustration of an exemplary display screen.

FIG. 10 is a flowchart of a flow of processing of controlling an image capturing device.

FIG. 11 is a flowchart of a flow of processing of determining a partial image.

FIG. 12 is an illustration of the functional blocks of a display control device.

FIG. 13 is an illustration of an exemplary display screen.

FIG. 14 is a flowchart of a flow of processing of associating the classification of an event with the portion of a human figure.

FIG. 15 is a schematic illustration of the hardware configuration of a display control device.

### DESCRIPTION OF THE EMBODIMENTS

Embodiments of the present disclosure will be described below with reference to the accompanying drawings. Note that the configurations in the following embodiments are just exemplary, and thus the present disclosure is not limited to the illustrated configurations.

### First Embodiment

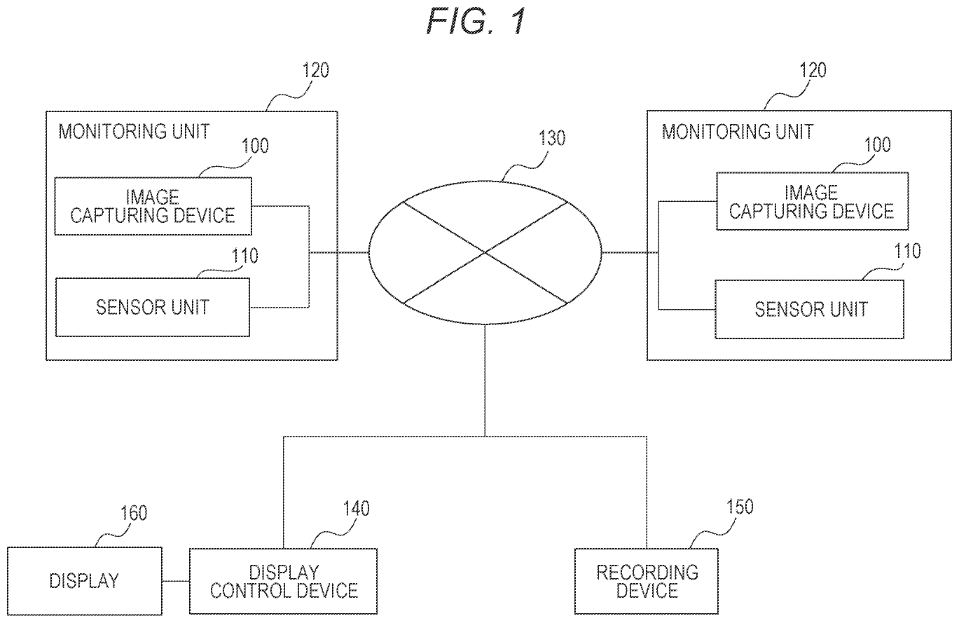

FIG. 1 is an illustration of the configuration of a system according to the present embodiment. The system according to the present embodiment includes monitoring units 120 each including an image capturing device 100 and a sensor unit 110, a display control device 140, a recording device 150, and a display 160.

The image capturing devices 100, the sensor units 110, the display control device 140, and the recording device 150 are connected through a network 130. For example, the network 130 includes a plurality of routers, a plurality of switches, and a plurality of cables compliant with a communication standard, such as ETHERNET (registered trademark).

Note that the network 130 may include, for example, the Internet, a wired local area network (LAN), a wireless LAN, or a wide area network (WAN).

Each of the image capturing devices 100 captures an image. Image data based on the image captured by the image capturing device 100 is transmitted to the display control device 140 and the recording device 150 through the network 130. Note that the image capturing device 100 transmits the image data of the captured image in association with an identification ID enabling the image capturing device 100 to be identified, to the display control device 140 and the recording device 150.

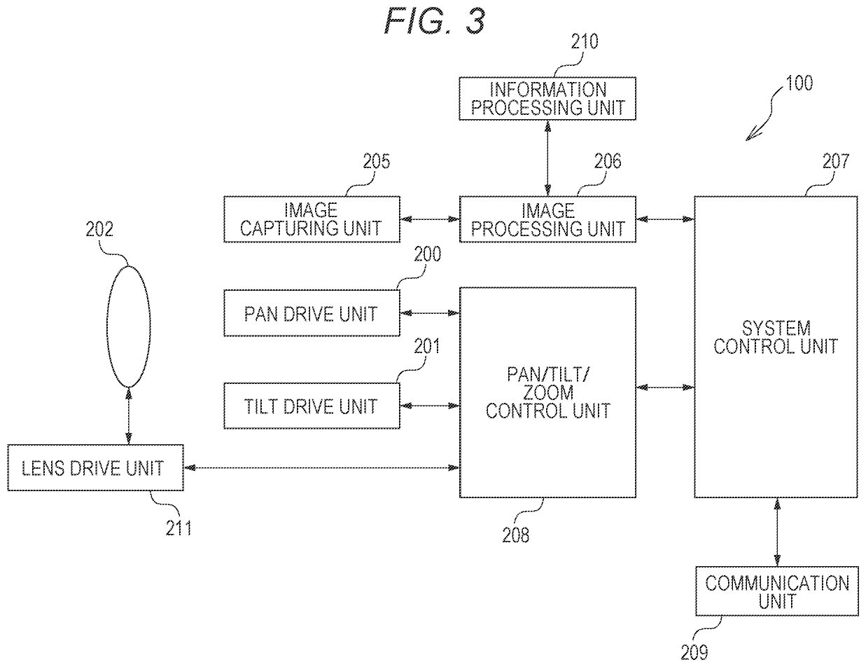

Note that the image capturing device 100 according to the present embodiment includes an information processing unit 210 that performs analytical processing to the captured image (to be described later with reference to FIG. 3). Then, the image capturing device 100 detects an event occurring in the capturing area in which the image capturing device 100 performs capturing, with the captured image subjected to the analytical processing.

The sensor unit 110 according to the present embodiment includes sensors, such as a temperature sensor, a human detection sensor, a motion sensor, an illuminance sensor, and a microphone.

The sensor unit 110 transmits information acquired through each sensor, to the image capturing device 100. For example, the human detection sensor transmits a signal indicating that a human figure has been detected in the capturing area, to the image capturing device 100. The microphone transmits a sound signal acquired in the capturing area, to the image capturing device 100.

The image capturing device 100 detects the event occurring in the capturing area, on the basis of the information transmitted from the sensor unit 110. For example, input of the signal indicating that the human detection sensor has detected the human figure in the capturing area, causes the image capturing device 100 to detect that the human figure exists in the capturing area, as the event. Note that the sensor unit 110 may include one sensor or a plurality of sensors.

The image capturing device 100 transmits the image data of the captured image, information indicating the time of capturing of the image, the identification ID enabling the image capturing device 100 that has captured the image, to be identified, and information indicating the detected event, to the display control device 140 and the recording device 150.

The display control device 140 causes the display 160 to display the image captured by the image capturing device 100, in arrangement. While browsing the displayed image, a user can monitor, for example, the presence or absence of abnormality in the capturing area.

The recording device 150 records the image data of the image captured by the image capturing device 100, the time of capturing of the image, the identification ID of the image capturing device 100 that has captured the image, and the information indicating the detected event, in association. Then, in accordance with a request from the display control device 140, the recording device 150 may transmit, for example, the image data of the image captured by the image capturing device 100, to the display control device 140.

For example, the display 160 includes a liquid crystal display (LCD). The display 160 is communicably connected to the display control device 140 through a display cable compliant with a communication standard, such as high definition multimedia interface (HDMI) (registered trademark).

The display 160 functioning as a display unit, displays the image captured by the image capturing device 100 or a setting screen for control of the image capturing device 100 or for a request for image distribution. Note that the display 160 may be integrally formed with the casing of the display control device 140.

Note that the number of monitoring units 120 each including the image capturing device 100 and the sensor unit 110, is not particularly limited. For example, the system according to the present embodiment may include one monitoring unit 120 or may include several tens to several hundreds of monitoring units 120.

According to the present embodiment, one monitoring unit 120 includes the image capturing device 100 and the sensor unit 110. Note that the sensor unit 110 may be integrally formed with the casing of the image capturing device 100. In that case, the image capturing device 100 itself functions as the monitoring unit.

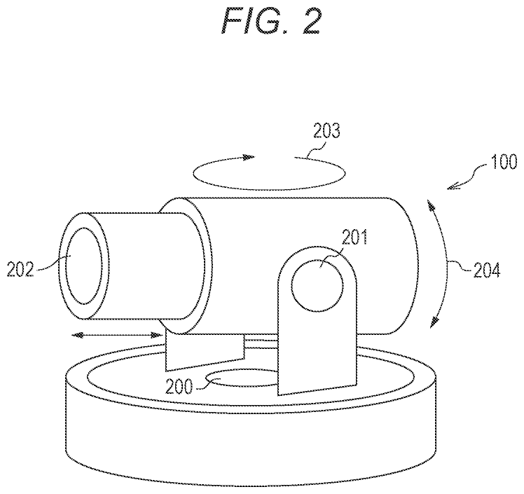

Next, the image capturing device 100 according to the present embodiment will be described with reference to FIGS. 2 and 3. FIG. 2 is an illustration of the external appearance of the image capturing device 100 according to the present embodiment, FIG. 3 is an illustration of the functional blocks of the image capturing device 100 according to the present embodiment.

The optical axis of a lens 202 is identical to the capturing direction of the image capturing device 100, beam of light passes through the lens 202, resulting in image formation on the image capturing element of an image capturing unit 205.

A lens drive unit 211 including a drive system of driving the lens 202, changes the focal length of the lens 202. The lens drive unit 211 is controlled by a pan/tilt/zoom control unit 208.

A pan drive unit 200 including a mechanical drive system of performing a pan operation and a motor as the drive source, performs swivel drive for swiveling the capturing direction of the image capturing device 100 in a pan direction 203. Note that the pan drive unit 200 is controlled by the pan/tilt/zoom control unit 208.

A tilt drive unit 201 including a mechanical drive system of performing a tilt operation and a motor as the drive source, performs pivot drive of pivoting the capturing direction of the image capturing device 100 in a tilt direction 204. Note that the tilt drive unit 201 is controlled by the pan/tilt/zoom control unit 208.

For example, the image capturing element of the image capturing unit 205 (not illustrated) includes a charge coupled device (CCD) sensor or a complementary metal oxide semiconductor (CMOS) sensor. Then, the image capturing unit 205 photoelectrically converts the subject image formed through the lens 202, to generate an electrical signal.

An image processing unit 206 performs, for example, processing of converting the electrical signal photoelectrically converted by the image capturing unit 205 into a predetermined digital signal and compression encoding processing, to generate image data.

The pan/tilt/zoom control unit 208 controls the pan drive unit 200, the tilt drive unit 201, and the lens drive unit 211, on the basis of an instruction transferred from a system control unit 207.

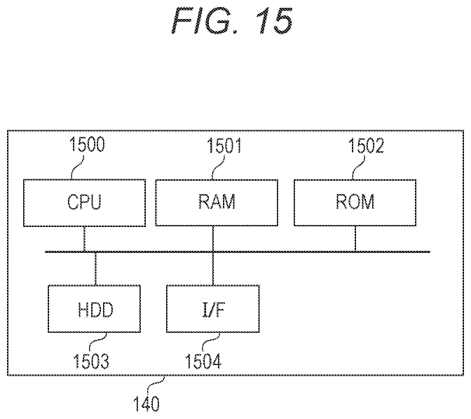

A communication unit 209 can be achieved by an I/F 1504 to be described later with reference to FIG. 15, and communicates with the sensor unit 110, the display control device 140, and the recording device 150.

For example, the communication unit 209 transmits the generated image data to the display control device 140. The communication unit 209 receives a command transmitted by the display control device 140, and then transfers the command to the system control unit 207. The communication unit 209 receives the information detected by the sensors from the sensor unit 110.

The information processing unit 210 performs the analytical processing to the image data generated by the image processing unit 206, to detect the event occurring in the capturing area. Note that, according to the present embodiment, examples of the analytical processing of the information processing unit 210 include processing of moving object detection, processing of intrusion detection, and processing of human body detection.

The moving object detection includes processing of detecting a moving object included in the image captured by the image capturing device 100, with inter-frame difference or background subtraction. The intrusion detection includes processing of detecting intrusion of a moving object into an area previously set by the user, in the captured image. The human body detection includes processing of detecting a human figure included in the image by performance of processing such as pattern matching with a collation pattern (dictionary).

Note that the information processing unit 210 is required at least to perform the analytical processing necessary for detection of the event occurring in the capturing area, Thus, the type and the number of pieces of analytical processing of the information processing unit 210 are not particularly limited.

The information processing unit 210 detects the event occurring in the capturing area, on the basis of the information acquired from the sensor unit 110, received by the communication unit 209.

Note that the information processing unit 210 may be included in the display control device 140. In this case, for example, the image data of the image captured by the image capturing device 100 and the information acquired by the sensors of the sensor unit 110 in each monitoring unit, are transmitted to the display control device 140. Then, the information processing unit 210 of the display control device 140 detects the event occurring in the capturing area, on the basis of the image data and the information acquired by the sensors.

The system control unit 207 can be achieved by a CPU 1500 to be described later with reference to FIG. 15, and controls the entirety of the image capturing device 100 to perform the following processing, for example. That is, the system control unit 207 analyzes a command of controlling, for example, the capturing direction or the zoom value of the image capturing device 100, transferred from the communication unit 209, and performs processing corresponding to the command. The system control unit 207 provides the pan/tilt/zoom control unit 208 with an instruction for a pan/tilt/zoom operation.

The system control unit 207 transmits the image data of the image, the information regarding the time of capturing of the image, the identification ID of the image capturing device 100, the information indicating the event detected by the information processing unit 210, and capturing information at the capturing of the image in association through the communication unit 209.

The capturing information according to the present embodiment includes information indicating the panning angle and the tilting angle of the image capturing device 100 and the zoom value of the image capturing device 100 at the capturing of the image by the image capturing device 100, acquired from the pan/tilt/zoom control unit 208.

Note that the panning angle is the angle of the capturing direction (optical axis) in the pan direction 203 of the image capturing device 100 when one drive end of the pan drive unit 200 is defined as 0°. The tilting angle is the angle of the capturing direction (optical axis) in the tilt direction 204 of the image capturing device 100 when one drive end of the tilt drive unit 201 is defined as 0°. Note that the zoom value of the image capturing device 100 when the image capturing device 100 captures the image, is calculated from the focal length of the lens 202.

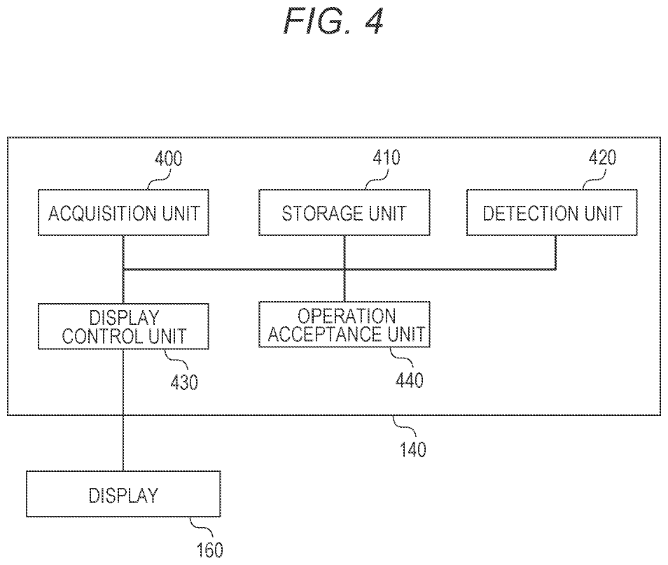

Next, the display control device 140 according to the present embodiment will be described with reference to an illustration of the functional blocks of the display control device 140 illustrated in FIG. 4. The display control device 140 according to the present embodiment includes an acquisition unit 400, a storage unit 410, a detection unit 420, a display control unit 430, and an operation acceptance unit 440.

Note that the functional blocks illustrated in FIG. 4 are achieved by execution of a computer program stored in a ROM 1502 of the display control device 140 by the CPU 1500 of the display control device 140.

The acquisition unit 400 acquires the identification ID identifying an image capturing device 100 and the image captured by the image capturing device 100 corresponding to the identification ID. The acquisition unit 400 acquires the information indicating the event occurring in the capturing area in which the image capturing device 100 corresponding to the identification ID performs capturing.

The storage unit 410 stores a table including the identification ID identifying the image capturing device 100, the classification of the event, and the portion of the human figure in association.

Performance of processing such as the pattern matching with the collation pattern (dictionary), causes the detection unit 420 to detect the position and the size of the human figure included in the image captured by the image capturing device 100.

Note that, in a case where the information processing unit 210 of the image capturing device 100 detects the position and the size of the human figure included in the image, the display control device 140 according to the present embodiment does not necessarily include the detection unit 420. In that case, the acquisition unit 400 is required at least to acquire information regarding the position and the size of the human figure included in the image, from the image capturing device 100.

Note that, according to the present embodiment, the detection unit 420 detects the upper body of the human figure. The position of the human figure is the position of the center of gravity in the area of the upper body in the image. The size of the human figure is the number of pixels in the vertical direction in the area of the upper body on the image.

The display control unit 430 causes the display 160 to display the image captured by the image capturing device 100, in arrangement, and causes the display 160 to display a frame indicating the position and the size of the human figure detected by the detection unit 420, in superimposition on the image.

The display control unit 430 displays, onto the display 160, a marker indicating the level of reference size to be criterial at enlargement of the image displayed on the display 160.

The display control unit 430 causes the display 160 to display an image generated by enlargement processing with respect to the specific portion of the human figure included in the image of the capturing area. Note that the specific portion of the human figure varies in accordance with the classification of the event acquired by the acquisition unit 400.

Note that, according to the present embodiment, the image generated by the enlargement processing results from enlargement in display such that the size of the specific portion is identical to the reference size. Note that the specific portion of the human figure according to the present embodiment is any of the entire body, the upper body, the face, and a hand of the human figure.

The operation acceptance unit 440 acquires information regarding an operation of the user through a user interface (UI), such as a mouse or a keyboard.

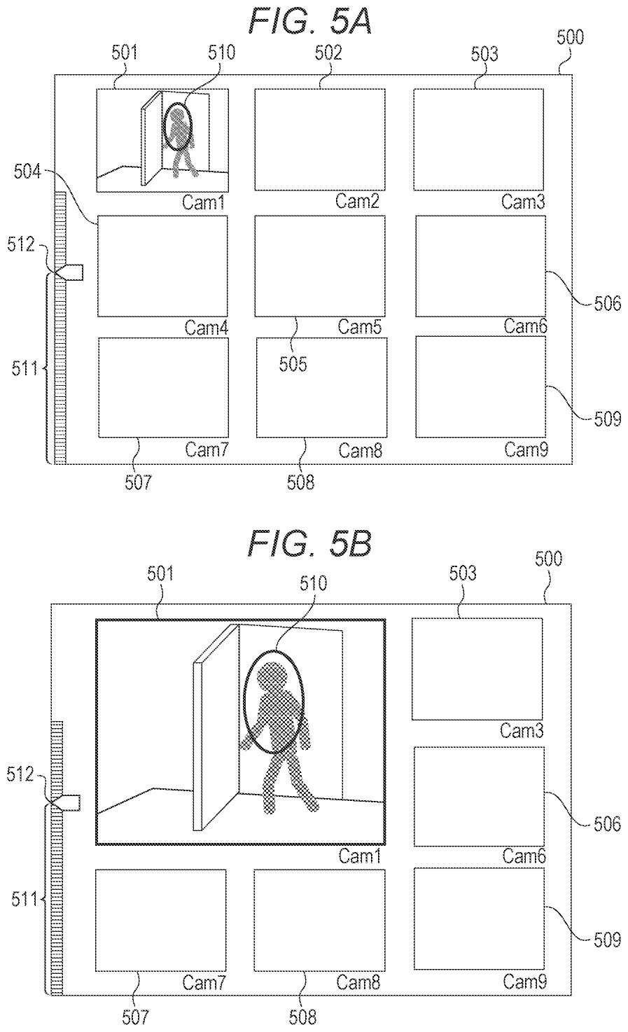

Next, the display control device 140 according to the present embodiment will be described with reference to FIGS. 5A and 5B. FIGS. 5A and 5B are each an illustration of an exemplary screen displayed on the display 160 by the display control device 140.

The screen 500 illustrated in FIG. 5A includes image windows 501 to 509 each allowing display of the image captured by the image capturing device 100. The image windows 501 to 509 correspond to the identification IDs (Cam1 to Cam9) of the plurality of image capturing devices 100 different in installed location, respectively, and allow display of the respective images captured by the image capturing devices 100.

For example, the image window 501 allows display of the image captured by the image capturing device 100 of which identification ID is “Cam1”, and the image window 502 allows display of the image captured by the image capturing device 100 of which identification ID is “Cam2”.

Note that the image to be displayed on each image window may be captured by the same image capturing device 100. In this case, the images different in the time of capturing are displayed on the respective image windows.

A frame 510 indicating the position and the size of the human figure detected by the detection unit 420 to the image captured by the image capturing device 100 of which identification ID is “Cam1”, is displayed in superimposition on the image. Because the detection unit 420 according to the present embodiment detects the upper body of the human figure included in the image, the frame 510 indicates the position and the size of the upper body of the human figure.

A marker 511 indicates the reference size to be criterial at enlargement of an image displayed on the display 160 by the display control unit 430. A grid 512 allows setting of the level in the vertical direction of the marker 511 (reference size). The operation acceptance unit 440 accepts information. regarding vertical movement of the grid 512 by the user through the UI (not illustrated), such as the mouse or the keyboard.

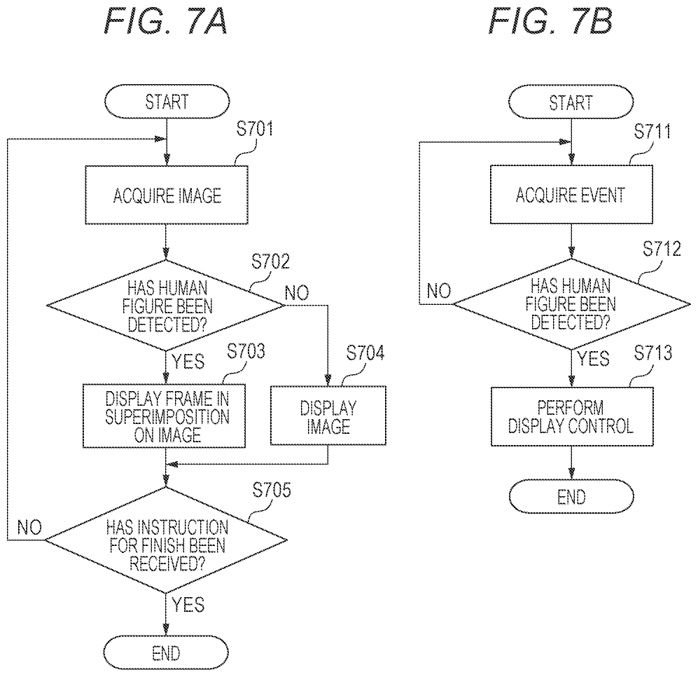

FIG. 5B illustrates an exemplary display of the image generated by the enlargement processing with respect to the specific portion of the human figure included in the image of the capturing area, by the display control unit 430. In this case, the image is enlarged in display such that the size in the vertical direction of the entire body that is the portion of the human figure included in the image is identical to the reference size, corresponding to the classification of the event occurring in the capturing area of the image capturing device 100 of which identification ID is “Cam1”. Processing to be performed by the display control unit 430 in such a case, will be described in detail below with reference to flows illustrated in FIGS. 7A and 7B.

Next, the flows of processing of the display control device 140 according to the present embodiment, will be described with reference to flowcharts illustrated in FIGS. 7A and 7B. The processing in the flowchart illustrated in FIG. 7A allows detection of the human figure included in the acquired image, and causes the display 160 to display the frame indicating the position and the size of the detected human figure, in superimposition on the image. The processing in the flowchart illustrated in FIG. 7B causes the display 160 to display the image generated by the enlargement processing with respect to the portion of the human figure corresponding to the classification of the event acquired.

Note that, exemplarily, the processing in the flowcharts illustrated in FIGS. 7A and 7B is executed by the functional blocks illustrated in FIG. 4 achieved by execution of the computer program stored in the ROM 1502 of the display control device 140 by the CPU 1500 of the display control device 140. Note that part of the processing in the flowcharts illustrated in FIGS. 7A and 7B may be executed by dedicated hardware.

First, the processing in the flowchart illustrated in FIG. 7A will be described here. Note that the processing illustrated in FIG. 7A starts in a case where the image data of the image captured by an image capturing device 100 and the identification ID enabling the image capturing device 100 that has captured the image, to be identified, are transmitted from the image capturing device 100 or the recording device 150 to the display control device 140.

At step S701, the acquisition unit 400 acquires the identification ID of the image capturing device 100 and the image captured by the image capturing device 100 corresponding to the identification ID.

Next, at step S702, the detection unit 420 detects the position and the size of the human figure included in the image captured by the image capturing device 100. In a case where the human figure has been detected, the processing proceeds to step S703. In a case where no human figure has been detected, the processing proceeds to step S704. Note that, at step S701, in a case where the respective images have been acquired from a plurality of image capturing devices 100, the detection unit 420 performs human figure detection to each of the plurality of images.

At step S703, the display control unit 430 causes the display 160 to display the image captured by the image capturing device 100 onto the image window corresponding to the identification ID. Furthermore, the display control unit 430 causes the display 160 to display the image on which the frame indicating the position and the size of the human figure detected by the detection unit 420 is superimposed, onto the image window corresponding to the identification ID of the image capturing device 100.

For example, in a case where the human figure has been detected in the image captured by the image capturing device 100 of which identification ID is “Cam1”, the display control unit 430 displays the image on which the frame indicating the position and the size of the human figure is superimposed, onto the image window 501 (illustrated in FIG. 5A).

At step S704, the display control unit 430 causes the display 160 to display the image captured by the image capturing device 100, onto the image window corresponding to the identification ID.

At step S705, in a case where an instruction for finish of the processing has been received from the user, the processing finishes. In a case where no instruction for finish of the processing has been received, the processing proceeds to step S701.

Next, the processing of enlarging and displaying the image illustrated in FIG. 7B, will be described. Note that the processing illustrated in FIG. 7B starts in a case where the identification ID of the image capturing device 100 and the information indicating the event occurring in the capturing area of the image capturing device 100 having the identification ID are transmitted from the image capturing device 100 or the recording device 150 to the display control device 140.

First, at step S711, the acquisition unit 400 acquires the identification ID of the image capturing device 100 and the information indicating the event occurring in the capturing area in which the image capturing device 100 having the identification ID performs capturing.

Next, at step S712, in a case where the human figure has been detected in the image of the capturing area in which the event has occurred, the processing proceeds to step S713. In a case where no human figure has been detected, the processing proceeds to step S711.

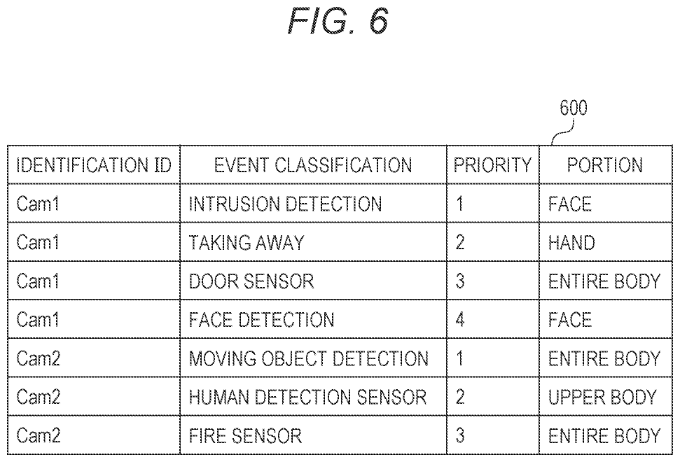

At step S713, the display control unit 430 causes display of the image generated by the enlargement processing with respect to the specific portion of the human figure included in the image of the capturing area. Note that the specific portion varies in accordance with the classification of the event acquired by the acquisition unit 400. Note that, according to the present embodiment, the image generated by the enlargement processing results from enlargement in display such that the size of the specific portion is identical to the reference size. The processing of the display control unit 430 at step S713 will be described below with reference to FIGS. 5A, 5B, and 6.

Note that a table 600 illustrated in FIG. 6 including the identification ID identifying the image capturing device 100, the classification of the event, priority, and the portion of the human figure in association, is stored in the storage unit 410. In the same monitoring unit, the value in priority is set so as to be unique constantly.

The display control unit 430 according to the present embodiment specifies the size in the image of the portion corresponding to the classification of the event acquired by the acquisition unit 400, on the basis of the table 600 stored in the storage unit 410.

Thus, the display control unit 430 multiplies the size in the image of the human figure detected by the detection unit 420, by a factor corresponding to the portion determined by the classification of the event acquired, to specify the size in the image of the portion corresponding to the classification of the event. Then, the display control unit 430 enlarges the image in display such that the size of the portion specified is identical in level to the reference size.

For example, as illustrated in FIG. 5A, it is assumed that, at step S711, the acquisition unit 400 acquires the information regarding the event that a motion sensor installed at a door has detected opening/closing of the door in the capturing area in which the image capturing device 100 of which identification ID is “Cam1”, performs capturing. Note that the classification of the event detected in this case is “door sensor”,

The display control unit 430 specifies the size in the image of the entire body of the human figure that is the portion corresponding to “door sensor” that is the classification of the event, on the basis of the table 600 stored in the storage unit 410.

Thus, the display control unit 430 multiplies the size in the vertical direction in the image of the upper body of the human figure detected by the detection unit 420, by a factor of 2. corresponding to the entire body that is the portion corresponding to the classification of the event, to specify the size in the vertical direction in the image of the entire body of the human figure. Note that the size in the vertical direction in the image is the number of pixels in the vertical direction in the image.

Specifically, when the size in the vertical direction of the frame 510 indicating the upper body of the human figure detected by the detection unit 420 is 100 pixels, the display control unit 430 specifies 200 pixels double in size as the size of the entire body of the human figure.

Then, the display control unit 430 enlarges the image in display such that the size of the entire body of the human figure specified (200 pixels) is identical to the size in the vertical direction of the marker 511 (here, 500 pixels). Thus, according to the present embodiment, the image generated by the enlargement processing results from enlargement in display (image window) such that the size of the specific portion of the human figure is identical to a predetermined size (size in the vertical direction of the marker 511). In FIGS. 5A and 5B, the image window 501 illustrated in FIG. 5A enlarges to the image window 501 illustrated in FIG. 5B.

The processing described above allows enlargement of the image on the display 160 with respect to the portion of the human figure corresponding to the classification of the event acquired.

Note that, in a case where the acquisition unit 400 has acquired a plurality of events at step S711, with reference to the priority indicated in the table 600, the display control unit 430 enlarges the image with respect to the portion corresponding to the classification of the event in descending order of values in the priority.

Note that, for specification of the size of the portion corresponding to the classification of the event, the factor by which the display control unit 430 multiplies the size of the human figure detected by the detection unit 420, is a previously set value.

According to the present embodiment, the portion of the human figure to be detected by the detection unit 420 is the upper body. Thus, for specification of the size in the vertical direction in the image of the face that is the portion corresponding to an event, the factor by which the size in the vertical direction in the image of the upper body is multiplied, is ½. For specification of the size in the vertical direction in the image of the hand, the factor by which the size in the vertical direction in the image of the upper body is multiplied, is ⅓. For specification of the size in the vertical direction in the image of the entire body, the factor by which the size in the vertical direction in the image of the upper body is multiplied, is 2.

Note that it is assumed that processing such as the pattern matching with the collation pattern (dictionary) corresponding to each portion of the human figure enables the detection unit 420 to detect the size and the position of each portion of the human body. In this case, at step S713, the display control unit 430 may enlarge the image in display, on the basis of the size of each portion detected by the detection unit 420.

In this case, the display control unit 430 specifies the size of the portion corresponding to the classification of the event acquired by the acquisition unit 400 from the portion of the human figure included in the image of the capturing area, on the basis of the result obtained by the detection of the detection unit 420. Then, the display control unit 430 enlarges the image on the display 160 in display such that the size of the portion corresponding to the classification of the event is identical to the reference size.

Note that the reference size according to the present embodiment is set by an operation of the user to the grid 512, but may be a previously registered predetermined size.

As described above, the display control device 140 according to the present embodiment, causes the display 160 to display the image generated by the enlargement processing with respect to the specific portion of the human figure included in the image. According to the present embodiment, the image generated by the enlargement processing results from enlargement in display such that the size of the specific portion corresponding to the classification of the event acquired is identical to the reference size. This arrangement enables the portion that the user desires to verify, to be visually identified, in accordance with the classification of the event occurring in the capturing area.

### Second Embodiment

According to the first embodiment, the image generated by the enlargement processing results from enlargement in display such that the size of the specific portion corresponding to the classification of the event acquired is identical to the reference size, but the present disclosure is not limited to this. According to the present embodiment, an image generated by enlargement processing results from capturing by an image capturing device 100 having a zoom value controlled with respect to a specific portion corresponding to the classification of an event acquired.

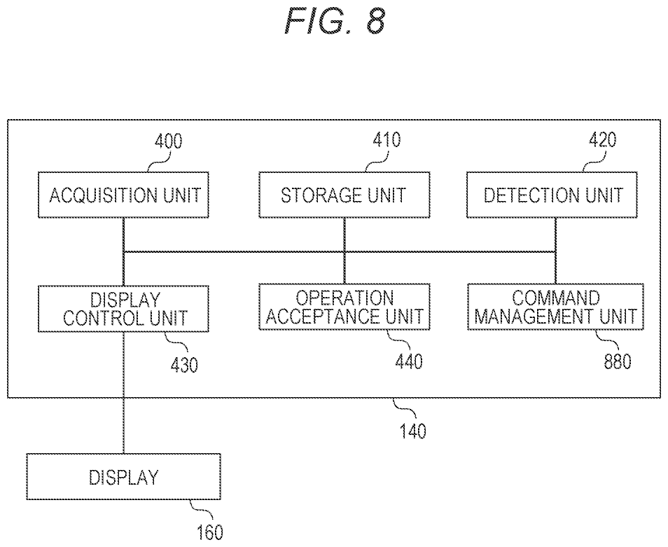

A display control device 140 according to the second embodiment will be described below with reference to FIGS. 8 to 10. Note that constituent elements and processing the same as or equivalent to those according to the first embodiment are denoted with the same reference signs, and thus the duplicate descriptions thereof will be appropriately omitted.

First, the display control device 140 according to the present embodiment will be described with reference to the functional blocks of the display control device 140 according to the present embodiment illustrated in FIG. 8. The display control device 140 according to the present embodiment includes an acquisition unit 400, a storage unit 410, a detection unit 420, a display control unit 430, an operation acceptance unit 440, and a command management unit 880.

Note that the functional blocks illustrated in FIG. 8 are achieved by execution of a computer program stored in a ROM 1502 of the display control device 140 by a CPU 1500 of the display control device 140.

The respective functions of the acquisition unit 400, the storage unit 410, the detection unit 420, and the operation acceptance unit 440 are similar to those described with reference to FIG. 4 in the first embodiment, and thus the descriptions thereof will be omitted.

The display control unit 430 causes a display 160 to display the image generated by the enlargement processing with respect to the specific portion of a human figure included in the image of a capturing area. Note that the specific portion varies in accordance with the classification of the event acquired by the acquisition unit 400. Note that, according to the present embodiment, the image generated by the enlargement processing results from capturing by the image capturing device 100 having the zoom value in zoom function controlled by a command generated by the command management unit 880 such that the size of the specific portion is identical to a predetermined size.

The command management unit 880 generates the command for controlling the capturing direction and the zoom value of the image capturing device 100, and transmits the command to the image capturing device 100 through an I/F 1504 of the display control device 140.

The command management unit 880 according to the present embodiment generates the command for controlling the image capturing device 100 to increase the zoom value of the image capturing device 100 with respect to the specific portion corresponding to the classification of the event acquired by the acquisition unit 400 from the portion of the human figure included in the image of the capturing area.

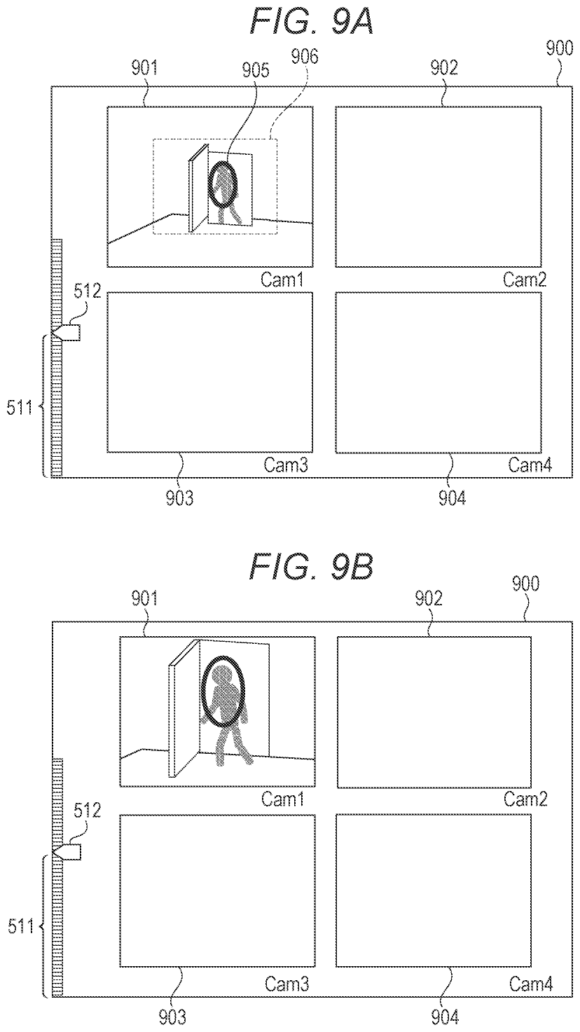

Next, the display control device 140 according to the present embodiment will be described with reference to FIGS. 9A and 9B. FIGS. 9A and 9B are each an illustration of an exemplary screen displayed on the display 160 by the display control device 140.

The screen 900 illustrated in FIG. 9A includes image windows 901 to 904 each indicating the image captured by the image capturing device 100. The image windows 901 to 904 correspond to the identification IDs (Cam1 to Cam4) of the plurality of image capturing devices 100 different in installed location, respectively, and allow display of the respective images captured by the image capturing devices 100. Note that the image windows 901 to 904 correspond to “Cam1” to “Cam4” each as the identification ID, respectively.

A frame 905 indicating the position and the size of the human figure detected by the detection unit 420 to the image captured by the image capturing device 100 of which identification ID is “Cam1”, is displayed in superimposition on the image.

An area 906 indicates the capturing area of the image capturing device 100 in a case where the capturing direction and the zoom value of the image capturing device 100 are controlled with respect to the portion of the human figure included in the captured image.

The command management unit 880 generates the command for controlling the image capturing device 100 having “Cam1” such that the area 906 is identical to the capturing area.

Note that the command management unit 880 generates the command for controlling the capturing direction of the image capturing device 100 having “Cam1” (pan direction and tilt direction) such that the position of the human figure included in the image is identical to the center of the image. Note that the position of the human figure is the center of gravity in the area on the image of the upper body of the human figure.

Note that, in a case where the detection unit 420 is capable of detecting the position and the size of each portion of the human figure included in the image, the command management unit 880 may perform the following processing. That is the command management unit 880 may generate the command for controlling the capturing direction of the image capturing device 100 (pan direction and tilt direction) such that the position of the portion corresponding to the classification of the event acquired by the acquisition unit 400 is identical to the center of the image. For example, in a case where the portion corresponding to the classification of the event acquired by the acquisition unit 400 is the face of the human figure, the command management unit 880 generates the command for controlling the capturing direction of the image capturing device 100 such that the center of gravity in the area of the face of the human figure in the image is identical to the center of the image to be captured.

The command generated by the command management unit 880 is transmitted to the image capturing device 100 having “Cam1”, and then a system control unit 207 of the image capturing device 100 analyzes the transmitted command. Then, the system control unit 207 provides a pan/tilt/zoom control unit 208 with an instruction for a pan/tilt/zoom operation, in accordance with the command.

The image that the image capturing device 100 having “Cam1” controlled in this manner captures, results in the image of the image window 901 illustrated in FIG. 9B.

Note that, corresponding to the classification of the event occurring in the capturing area of the image capturing device 100 of which identification ID is “Cam1”, the zoom value of the image capturing device 100 having “Cam1” is set large such that the size in the vertical direction in the image of the entire body of the human figure is identical to the size in the vertical direction of a marker 511. Note that, as the zoom value increases, the image that image capturing device 100 captures enlarges.

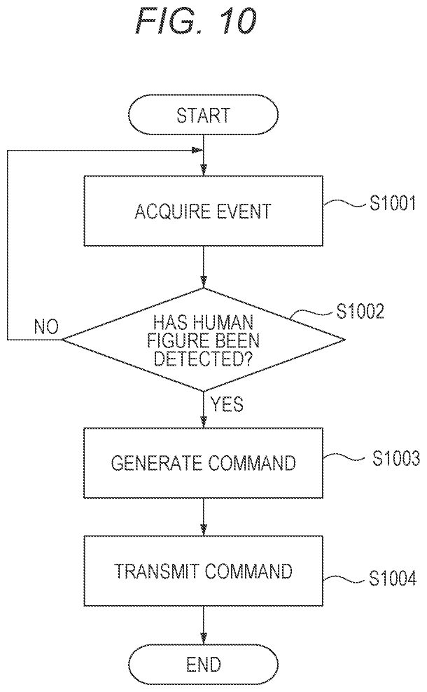

Next, the display control device 140 according to the second embodiment will be described with reference to a flowchart illustrated in FIG. 10. The processing in the flowchart illustrated in FIG. 10 allows control of the capturing direction and the zoom value of the image capturing device 100 with respect to the portion of the human figure corresponding to the classification of the event acquired.

Note that, exemplarily, the processing in the flowchart illustrated in FIG. 10 is executed by the functional blocks illustrated in FIG. 8 achieved by execution of the computer program stored in the ROM 1502 of the display control device 140 by the CPU 1500. Note that part of the processing in the flowchart illustrated in FIG. 10 may be executed by dedicated hardware.

Note that the processing illustrated in FIG. 10 starts in a case where the identification ID of an image capturing device 100 and information indicating the event occurring in the capturing area of the image capturing device 100 having the identification ID are transmitted from the image capturing device 100 or a recording device 150 to the display control device 140.

At step S1001, the acquisition unit 400 acquires the identification ID of the image capturing device 100 and the information indicating the event occurring in the capturing area in which the image capturing device 100 having the identification ID performs capturing.

Next, at step S1002, in a case where the human figure has been detected in the image of the capturing area in which the event has occurred, the processing proceeds to step S1003. In a case where no human figure has been detected, the processing proceeds to step S1001.

Next, at step S1003, the command management unit 880 generates the command for controlling the zoom value and the capturing direction of the image capturing device 100 with respect to the specific portion of the human figure included in the captured image. Note that the specific portion of the human figure varies in accordance with the classification of the event acquired by the acquisition unit 400. The processing of the command management unit 880 at step S1003 will be described below.

The command management unit 880 according to the present embodiment specifies the size in the image of the portion corresponding to the classification of the event acquired by the acquisition unit 400, on the basis of a table 600 stored in the storage unit 410.

Thus, the command management unit 880 multiples the size in the image of the human figure detected by the detection unit 420, by a factor corresponding to the portion determined by the classification of the event acquired, to specify the size in the image of the portion corresponding to the classification of the event. Then, the command management unit 880 generates the command for controlling the image capturing device 100 to have the zoom value at which the size of the portion specified is identical in level to a reference size.

For example, as illustrated in FIG. 9A, it is assumed that, at step S1001, the acquisition unit 400 acquires the information regarding the event that a motion sensor installed at a door has detected opening/closing of the door in the capturing area in which the image capturing device 100 of which identification ID is “Cam1”, performs capturing.

The command management unit 880 specifies the size in the image of the entire body of the human figure that is the portion corresponding to “door sensor” that is the classification of the event, on the basis of the table 600 stored in the storage unit 410.

Thus, the command management unit 880 multiples the size in the vertical direction in the image of the upper body of the human figure detected by the detection unit 420, by a factor of 2 corresponding to the entire body that is the portion corresponding to the classification of the event, to specify the size in the vertical direction in the image of the entire body of the human figure.

Specifically, the command management unit 880 specifies, as the size of the entire body of the human figure, a size double the size (number of pixels) in the vertical direction of the frame 905 indicating the upper body of the human figure detected by the detection unit 420.

Then, the command management unit 880 generates the command for controlling the image capturing device 100 to have the zoom value at which the size in the vertical direction in the image of the entire body of the human figure specified is identical to the marker 511 (reference size).

Next, at step S1004, the command management unit 880 transmits the command generated at step S1003, to the image capturing device 100 having the identification ID of a target to be controlled in zoom value and in capturing direction, through the I/F 1504.

As illustrated in FIGS. 9A and 9B, the image that the image capturing device 100 having “Cam1” controlled on the basis of the command transmitted at step S1004 captures, results in the image of the image window 901 illustrated in FIG. 9B.

Then, at steps S703 and S704, the display control unit 430 causes the display 160 to display the image generated by the enlargement processing. According to the present embodiment, the image generated by the enlargement processing results from capturing by the image capturing device 100 controlled on the basis of the command generated by the command management unit 880 at step S1003.

As described above, the display control device 140 according to the present embodiment causes the display 160 to display the image generated by the enlargement processing with respect to the specific portion of the human figure included in the image. According to the present embodiment, the image generated by the enlargement processing results from capturing by the image capturing device 100 having the zoom value controlled with respect to the specific portion corresponding to the classification of the event acquired. This arrangement enables the portion that a user desires to verify, to be visually identified, in accordance with the classification of the event occurring in the capturing area.

### Third Embodiment

According to the second embodiment, the image generated by the enlargement processing with respect to the specific portion of the human figure included in the image results from capturing by the image capturing device 100 controlled in capturing direction and in zoom value, but the present disclosure is not limited to this. According to a third embodiment, an image generated by enlargement processing results from enlargement of a partial image including the specific portion of a human figure included in an image.

In other words, according to the second embodiment, the image generated by the enlargement processing results from capturing by the image capturing device 100 with optical zooming performed, whereas, according to the present embodiment, the image generated by the enlargement processing results from performance of digital zooming.

A display control device 140 according to the third embodiment will be described below with reference to FIGS. 4, 9A, 9B, and 11. Note that constituent elements and processing the same as or equivalent to those according to the first embodiment and the second embodiment are denoted with the same reference signs, and thus the duplicate descriptions thereof will be appropriately omitted.

First, the display control device 140 according to the present embodiment will be described with reference to the functional blocks of the display control device 140 according to the present embodiment illustrated in FIG. 4.

The respective functions of an acquisition unit 400, a storage unit 410, a detection unit 420, and an operation acceptance unit 440 are similar to those described with reference to FIG. 4 in the first embodiment, and thus the descriptions thereof will be omitted.

A display control unit 430 displays the image generated by the enlargement processing with respect to the specific portion of the human figure included in the image of a capturing area. Note that the specific portion varies in accordance with the classification of an event acquired by the acquisition unit 400.

Note that, according to the present embodiment, the image generated by the enlargement processing includes the partial image including the specific portion, enlarged to the size of the image of an original (hereinafter, referred to as an original image).

Next, the display control device 140 according to the present embodiment will be described with reference to FIGS. 9A and 9B. According to the present embodiment, an area 906 illustrated in FIG. 9A indicates the area of the partial image including the specific portion corresponding to the classification of the event acquired by the acquisition unit 400, from the portion of the human figure included in the captured image.

The display control unit 430 according to the present embodiment determines the partial image such that the size of the portion corresponding to the classification of the event acquired is identical to reference size when the partial image including the specific portion corresponding to the classification of the event acquired is enlarged to the size of the original image.

In FIGS. 9A and 9B, the partial image determined on the basis of the classification of the event occurring in the capturing area of an image capturing device 100 of which identification ID is “Cam1”, is enlarged to the size of the original image, resulting in the image of an image window 901 illustrated in FIG. 9B.

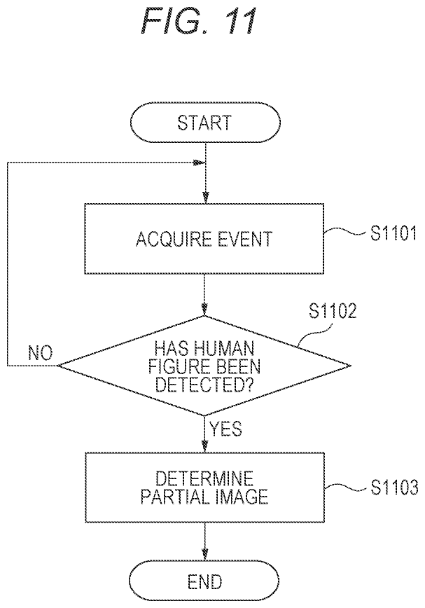

Next, the display control device 140 according to the third embodiment will be described with reference to a flowchart illustrated in FIG. 11. The processing in the flowchart illustrated in FIG. 11 allows display of the image generated by the enlargement processing with respect to the portion of the human figure corresponding to the classification of the event acquired.

Note that, exemplarily, the processing in the flowchart illustrated in FIG. 11 is executed by the functional blocks illustrated in FIG. 4 achieved by execution of a computer program stored in a ROM 1502 of the display control device 140 by a CPU 1500 of the display control device 140. Note that part of the processing in the flowchart illustrated in FIG. 11 may be executed by dedicated hardware.

Note that the processing illustrated in FIG. 11 starts in a case where the identification ID of an image capturing device 100 and information indicating the event occurring in the capturing area of the image capturing device 100 having the identification ID are transmitted from the image capturing device 100 or a recording device 150 to the display control device 140.

At step S1101 illustrated in FIG. 11, the acquisition unit 400 acquires the identification ID of the image capturing device 100 and the information indicating the event occurring in the capturing area in which the image capturing device 100 having the identification ID performs capturing.

Next, at step S1102, in a case where the human figure has been detected in the image of the capturing area in which the event has occurred, the processing proceeds to step S1101. In a case where no human figure has been detected, the processing proceeds to step S1103.

Next, at step S1103, the display control unit 430 determines the partial image including the specific portion corresponding to the classification of the event acquired, The processing of the display control unit 430 at step S1103 will be described below.

The display control unit 430 according to the present embodiment specifies the size in the image of the portion corresponding to the classification of the event acquired by the acquisition unit 400. Thus, the display control unit 430 multiples the size of the upper body on the image of the human figure detected by the detection unit 420, by a factor corresponding to the portion corresponding to the classification of the event acquired, to specify the size in the image of the portion corresponding to the classification of the event.

Then, the display control unit 430 determines the partial image so that enlargement of the partial image including the specific portion corresponding to the classification of the event, to the original image makes the size of the portion identical in level to the reference size.

For example, as illustrated in FIG. 9A, it is assumed that, at step S1101, the acquisition unit 400 acquires the information regarding the event that a motion sensor installed at a door has detected opening/closing of the door in the capturing area in which the image capturing device 100 of which identification ID is “Cam1”, performs capturing.

In this case, the display control unit 430 specifies the size in the image of the entire body of the human figure that is the specific portion corresponding to the classification of the event. Thus, the display control unit 430 multiplies the size in the vertical direction in the image of the upper body of the human figure detected by the detection unit 420, by a factor of 2 corresponding to the entire body that is the portion corresponding to the classification of the event, to specify the size in the vertical direction in the image of the entire body of the human figure.

Specifically, the display control unit 430 specifies, as the size of the entire body of the human figure, a size double the size in the vertical direction of a frame 905 indicating the upper body of the human figure detected by the detection unit 420.

Then, the display control unit 430 determines the partial image such that the size in the vertical direction in the image of the entire body of the human figure specified is identical to the size in the vertical direction of a marker 511 (reference size) when the partial image including the entire body of the human figure is enlarged to the size of the original image.

Note that, in this case, the display control unit 430 determines the partial image such that the position of the human figure detected is at the center. Here, because the position of the human figure is the center of gravity in the area of the upper body in the image of the human figure, the display control unit 430 determines the partial image such that the center of gravity is at the center.

Note that, in a case where the detection unit 420 is capable of detecting the position and the size of each portion of the human figure included in the image, the display control unit 430 may perform the following processing. That is, the display control unit 430 may determine the partial image such that the position of the portion corresponding to the classification of the event acquired by the acquisition unit 400 is identical to the center of the partial image. For example, in a case where the portion corresponding to the classification of the event acquired by the acquisition unit 400 is the face of the human figure, the display control unit 430 determines the partial image such that the center of gravity in the area of the face of the human figure in the image is identical to the center of the partial image.

Here, the display control unit 430 sets “x” to the identification ID of the image capturing device 100 that captures the image including the partial image determined at step S1103. In the processing at step S1103 and steps subsequent thereto, at steps S703 and S704, the display control unit 430 cuts out the area of the partial image determined at step S1103 from the image captured by the image capturing device 100 of which identification ID is “x”, and displays the area of the partial image in enlargement to the size of the original image.

As described above, the display control device 140 according to the present embodiment causes a display 160 to display the image generated by the enlargement processing with respect to the specific portion of the human figure included in the image. According to the present embodiment, the image generated by the enlargement processing results from enlargement of the partial image including the specific portion of the human figure included in the image. This arrangement enables the portion that the user desires to verify, to be visually identified, in accordance with the classification of the event occurring in the capturing area.

### Fourth Embodiment

A display control device 140 according to the present embodiment performs setting such that the identification ID identifying an image capturing device 100, the classification of an event, and the portion of a human figure are in association, on the basis of an operation of a user.

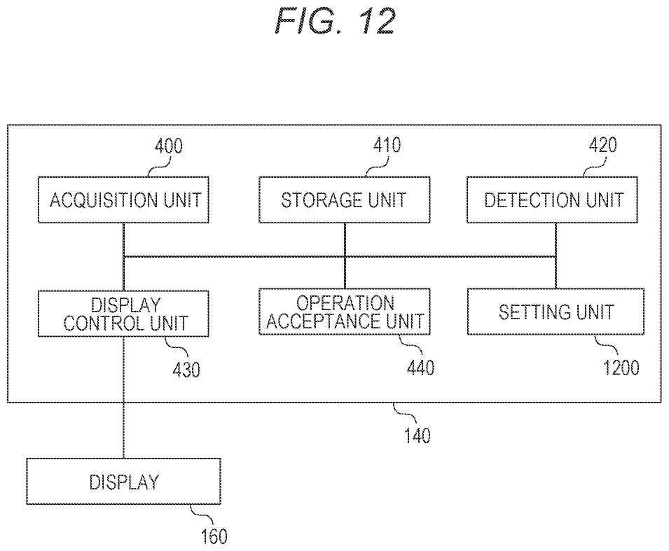

The display control device 140 according to the fourth embodiment will be described below with reference to FIGS. 12, 13, and 14. Note that constituent elements and processing the same as or equivalent to those according to the first embodiment are denoted with the same reference signs, and thus the duplicate descriptions thereof will be appropriately omitted.

The display control device 140 according to the present embodiment will be described with reference to the functional blocks of the display control device 140 according to the present embodiment illustrated in FIG. 12. The display control device 140 according to the present embodiment includes an acquisition unit 400, a storage unit 410, a detection unit 420, a display control unit 430, an operation acceptance unit 440, and a setting unit 1200.

Note that the functional blocks illustrated in FIG. 12 are achieved by execution of a computer program stored in a ROM 1502 of the display control device 140 by a CPU 1500 of the display control device 140.

The respective functions of the acquisition unit 400, the storage unit 410, the detection unit 420, and the operation acceptance unit 440 are similar to those described with reference to FIG. 4 in the first embodiment, and thus the descriptions thereof will be omitted.

In a case where the user selects the human figure detected by the detection unit 420, the display control unit 430 according to the present embodiment displays, onto a display 160, a plurality of icons expressing the portion of the human figure.

The display control unit 430 displays, onto the display 160, information indicating the classification of the event occurring in the capturing area of the image capturing device 100. Furthermore, the display control unit 430 changes the display mode of the information indicating the classification of the event selected by the user.

The setting unit 1200 sets the identification ID identifying the image capturing device 100, the classification of the event, and the portion of the human figure in association, on the basis of information regarding the operation of the user accepted by the operation acceptance unit 440. A table 600 as illustrated in FIG. 6 is set on the basis of the information associated by the setting unit 1200.

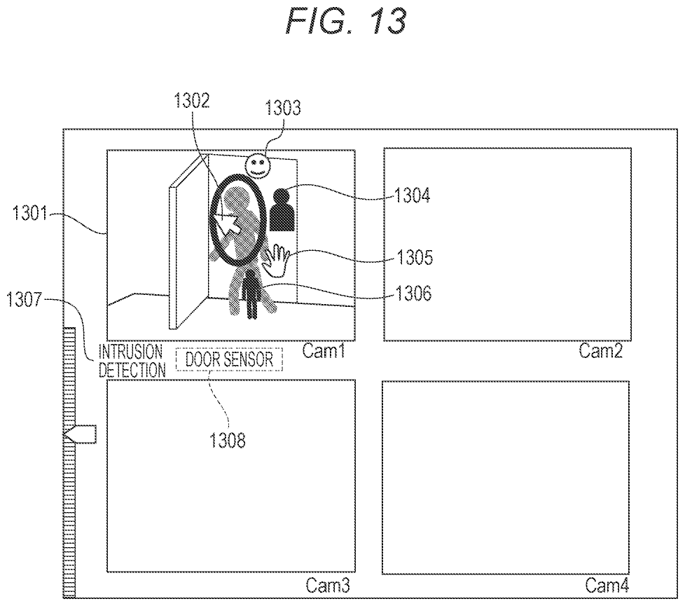

The display control device 140 according to the present embodiment will be described with reference to FIG. 13. According to the present embodiment, a cursor 1302 illustrated in FIG. 13 indicates a mouse cursor to be operated by the user. Icons 1303 to 1306 expressing the portion of the human figure, indicate a face, an upper body, a hand, and an entire body, respectively.

An event classification section 1307 includes information indicating the classification of the event occurring in the capturing area at capturing of an image to be displayed on an image window 1301. In FIG. 13, “intrusion detection” and “door sensor” are displayed as the classification of the event.

A frame 1308 is displayed for change of the display mode of the information indicating the classification of the event selected by the user with the cursor 1302.

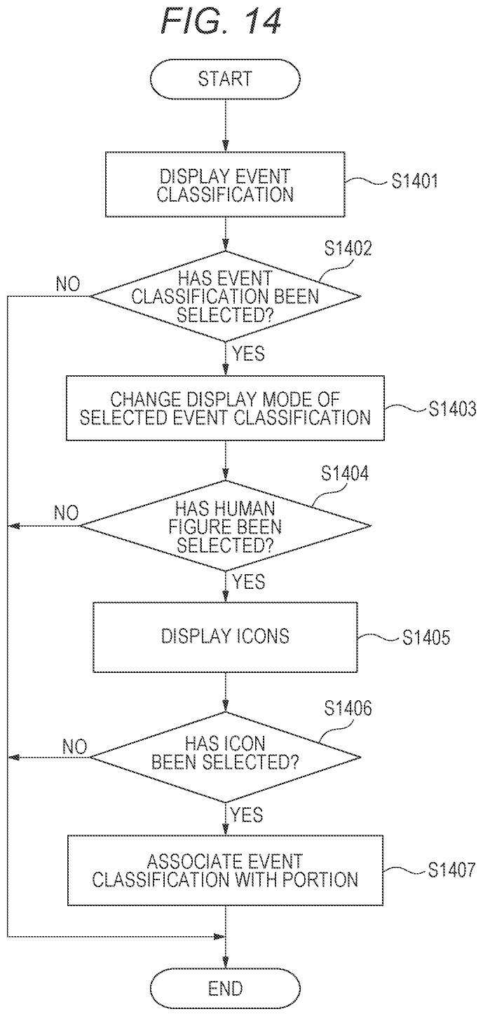

Next, the display control device 140 according to the fourth embodiment will be described with reference to a flowchart illustrated in FIG. 14. The processing in the flowchart illustrated in FIG. 14 allows setting of the table including the identification ID identifying an image capturing device 100, the classification of the event, and the portion of the human figure in association.

Note that, exemplarily, the processing in the flowchart illustrated in FIG. 14 is executed by the functional blocks illustrated in FIG. 12 achieved by execution of the computer program stored in the ROM 1502 of the display control device 140 by the CPU 1500 of the display control device 140. Note that part of the processing in the flowchart illustrated in FIG. 14 may be executed by dedicated hardware.

Note that, according to the present embodiment, the processing in the flowchart illustrated in FIG. 14 starts in a case where the acquisition unit 400 acquires the information indicating the event occurring in time capturing area in which the image capturing device 100 corresponding to the identification ID performs capturing.

At step S1401, the display control unit 430 displays, onto the display 160, the information indicating the classification of the event occurring in the capturing area of the image capturing device 100. Specifically, as illustrated in FIG. 13, the display control unit 430 displays the information indicating the classification of the event occurring in the capturing area of the image capturing device 100 of which identification ID is “Cam1”, under the image window 1301 corresponding to “Cam1”, in FIG. 13, “intrusion detection” and “door sensor” are displayed as the information indicating the classification of the event.

At step S1402, in a case where the operation acceptance unit 440 accepts information that the user has selected the classification of the event displayed at step S1401, the processing proceeds to step S1403. For no acceptance, the processing finishes.

At step S1403, the display control unit 430 changes the display mode of the information indicating the classification of the event selected by the user. For example, for change of the display mode, the display control unit 430 superimposes the frame 1308 onto “door sensor” that is the information indicating the classification of the event selected by the user.

At step S1404, in a case where the operation acceptance unit 440 accepts information that the user has selected a frame indicating the position and the size of the human figure, the processing proceeds to step S1405. For no acceptance, the processing finishes.

At step S1405, the display control unit 430 displays, onto the display 160, the plurality of icons expressing the corresponding portions of the human figure. Specifically, as illustrated in FIG. 13, the display control unit 430 displays the icons 1303 to 1306 expressing the portion of the human figure, around the human figure selected by the user.

At step S1406, in a case where the operation acceptance unit 440 accepts information that the user has selected a specific icon, the processing proceeds to step S1407. For no acceptance, the processing finishes.

At step S1407, the setting unit 1200 sets the classification of the event selected by the user at step S1402, the portion of the human figure selected at step S1406, and the identification ID of the image capturing device 100 in association. For example, in FIG. 13, in a case where the icon 1306 indicating the entire body has been selected, the setting unit 1200 sets “door sensor” that is the classification of the event, the entire body that is the portion of the human figure, and “Cam1” that is the identification ID of the image capturing device 100, in association. The information set by the setting unit 1200 is stored as the table 600 as illustrated in FIG. 6 into the storage unit 410.

As described above, the display control device 140 according to the present embodiment enables setting of the identification ID of the image capturing device 100, the classification of the event, and the portion of the human figure in association, with verification of the human figure included in the image displayed on the display 160, This arrangement enables setting of the table with improved convenience.

### Modification

According to the first, second, or third embodiment, the display control device 140 specifies the portion of the human figure corresponding to the classification of the event occurring in the capturing area, but the present disclosure is not limited to this, The display control device 140 may specify the portion of the human figure, on the basis of an operation of the user, without consideration of the event occurring in the capturing area.

For example, as illustrated in FIG. 13, in a case where the user operates the cursor 1302 to select the frame indicating the position and the size of the human figure detected by the detection unit 420, the display control unit 430 causes display of the icons 1303 to 1306. Then, the display control device 140 specifies the portion of the human figure indicated by an icon selected by the user from the plurality of icons displayed.

Then, the display control device 140 causes the display 160 to display the image generated by the enlargement processing with respect to the specific portion of the human figure included in the image.

### Additional Embodiment

Next, the hardware configuration of a display control device 140 for achieving each function in each embodiment, will be described with reference to FIG. 15. Note that a recording device 150 is achieved with a hardware configuration similar to the hardware configuration of the display control device 140 to be described below. For example, the functions of an image processing unit 206, a system control unit 207, a pan/tilt/zoom control unit 208, a communication unit 209, and an information processing unit 210 of an image capturing device 100 are achieved by a similar hardware configuration.

The display control device 140 according to the present embodiment includes a central processing unit (CPU) 1500, a random access memory (RAM) 1501, a read only memory (ROM) 1502, a hard disk drive (HDD) 1503, and an interface (I/F) 1504.

The CPU 1500 performs centralized control of the display control device 140.

The RAM 1501 temporarily stores a computer program to be executed by the CPU 1500. The RAM 1501 provides the CPU 1500 with a work area for execution of processing. For example, the RAM 1501 functions as a frame memory or functions as a buffer memory.

For example, the ROM 1502 stores a program for causing the CPU 1500 to control the display control device 140. The HDD 1503 is a storage device that records, for example, image data.

The I/F 1504 communicates with an external device (e.g., the image capturing device 100 or the recording device 150) in accordance with, for example, TCP/IP or HTTP through a network 130.

Note that the example that the CPU 1500 executes the processing has been given in each embodiment described above, but at least part of the processing of the CPU 1500 may be performed by dedicated hardware. For example, the processing of displaying a graphical user interface (GUI) and image data on the display 160 may be executed by a graphics processing unit (GPU). The processing of reading a program code from the ROM 1502 and developing the program code into the RAM 1501 may be executed by direct memory access (DMA) that functions as a transfer device.

Note that the present disclosure can he achieved by processing in which at least one processor reads and executes a program of achieving at least one function in each embodiment described above. The program may be provided to a system or a device including a processor through a network or a storage medium. The present disclosure can be achieved by a circuit that achieves at least one function in each embodiment described above (e.g., an application specific integrated circuit (ASIC)). Each unit of the image capturing device 100 may be achieved by the hardware illustrated in FIG. 15 or can be achieved by software.

The present disclosure together with the embodiments has been described above. However, the embodiments are just specifically exemplary for the present disclosure, and thus the technical scope of the present disclosure is not limited to the embodiments. That is, the present disclosure can be achieved in various modes without departing from the technical idea or the main sprit thereof. For example, any combination of the embodiments is included in the content disclosed in the present specification.

According to each embodiment above, the portion that the user desires to verify, can be visually identified, in accordance with the classification of the event occurring in the capturing area.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-143506, filed Jul. 31, 2018, which is hereby incorporated by reference herein in its entirety.

What is claimed is:

1. A display control device configured to cause a display unit to display an image captured by an image capturing device, the display control device comprising:
an acquisition unit configured to acquire a classification of an event occurring in a capturing area in Which the image capturing device performs capturing; and
a display control unit configured to cause the display unit to display an image generated by enlargement processing such that a size of a portion of a human figure included in the image of the capturing area is identical to a predetermined size, the portion of the human figure corresponding to the classification of the event acquired by the acquisition unit.

2. The display control device according to claim 1, further comprising:
a control unit configured to control a zoom value of the image capturing device,
wherein the image generated by the enlargement processing results from capturing by the image capturing device having the zoom value increased by the control unit such that the size of the portion of the human figure is identical to the predetermined size.

3. The display control device according to claim 1, wherein the image generated by the enlargement processing results from enlargement of a partial image including the portion of the human figure such that the size of the portion of the human figure is identical to the predetermined size.

4. The display control device according to claim 1, wherein the size of the portion of the human figure results from multiplication of a factor determined by a portion varying in accordance with the classification of the event acquired by the acquisition unit, by a size of the human figure.

5. The display control device according to claim 1, wherein the classification of the event includes at least one of human body detection, intrusion detection, and moving object detection.

6. The display control device according to claim 1, wherein the portion of the human figure is any of an entire body, an upper body, a face, and a hand of the human figure.

7. A display control method of causing a display unit to display an image captured by an image capturing device, the display control method comprising:
acquiring a classification of an event occurring in a capturing area in which the image capturing device performs capturing; and
causing the display unit to display an image generated by enlargement processing such that a size of a portion of a human figure included in the image of the capturing area is identical to a predetermined size, the portion of the human figure corresponding to the classification of the event acquired.

8. The display control method according to claim 7, further comprising:
controlling a zoom value of the image capturing device,
wherein the image generated by the enlargement processing results from capturing by the image capturing device having the zoom value increased such that the size of the portion of the human figure is identical to the predetermined size.

9. The display control method according to claim 7, wherein the image generated by the enlargement processing results from enlargement of a partial image including the portion of the human figure such that the size of the portion of the human figure is identical to the predetermined size.

10. The display control method according to claim 7, wherein the size of the portion of the human figure results from multiplication of a factor determined by a portion varying in accordance with the classification of the event acquired, by a size of the human figure.

11. The display control method according to claim 7, wherein the classification of the event includes at least one of human body detection, intrusion detection, and moving object detection.

12. The display control method according to claim 7, wherein the portion of the human figure is any of an entire body, an upper body, a face, and a hand of the human figure.

13. A computer-readable non-transitory recording medium storing a program for causing a computer to execute a display control method of causing a display unit to display an image captured by an image capturing device, the display control method comprising:
acquiring a classification of an event occurring in a capturing area in which the image capturing device performs capturing; and
causing the display unit to display an image generated by enlargement processing such that a size of a portion of a human figure included in the image of the capturing area is identical to a predetermined size, the portion of the human figure corresponding to the classification of the event acquired.
